(19) United States
(12) Patent Application Publication
(10) Pub. No.: US 2017/0158108 A1
(43) Pub. Date: Jun. 8, 2017

(54) MOBILE RETAIL TRUCK

(71) Applicant: Stephan Elbaz, Hoboken, NJ (US)

(72) Inventor: Stephan Elbaz, Hoboken, NJ (US)

(21) Appl. No.: 15/078,541

(22) Filed: Mar. 23, 2016

Related U.S. Application Data
(63) Continuation-in-part of application No. 29/547,594, filed on Dec. 4, 2015.

(51) Int. Cl. B60P 3/025; B60Q 5/00; B60H 1/00; G09F 21/04; G09F 27/00; B60R 7/10; B60R 3/02

(52) U.S. Cl. CPC B60P 3/0255; B60R 7/10; B60Q 5/00; B60R 3/02; G09F 21/04; G09F 27/00; B60H 1/00207; B60H 2001/00235; H04W 84/12

(57) ABSTRACT

A mobile retail motorized vehicle, having a motorized vehicle which features an exterior compartment mounted on a number of wheels, where the exterior compartment adapted and configured to hold a power source separate from the motorized vehicle power source; an exterior perimeter defined by at least one transparent enclosure and at least one entryway, where the at least one enclosure is defined by a second exterior perimeter. The mobile retail motorized vehicle also has an internal compartment, which has a retail showroom which is configured to display a plurality of merchandise items; and wherein the internal compartment further comprises a plurality of displays; and a solar powered lighting source; and an audio and speaker system.

### CLAIM OF PRIORITY

This application is a continuation-in-part application and claims priority to U.S. Design Application 29/547,594, entitled “Mobile Retail Truck” filed on Dec. 4, 2015, the contents of which are hereby fully incorporated by reference.

### FIELD OF THE EMBODIMENTS

The invention and its embodiments relate to a mobile retail motorized vehicle, namely used for retail purposes.

### BACKGROUND OF THE EMBODIMENTS

As advances in construction technologies have been made, the amount of materials available to someone when building their home has increased proportionally. Now more than ever are homeowners faced with a bevy of options as to how to decorate their home. Whether its closets, blinds, shades, flooring, lamps, chandeliers, chairs, tables, or something else, home decoration, unlike many other types of retail, require special space as many people enjoy seeing the materials that may be placed in their home so they might obtain a better idea of what they're looking for.

However, as consumers typically enjoy seeing full-scale models of blinds, shades, and closets, frequently large spaces are required so that they may view multiple models. Further, in areas where custom blinds, shades, and closets are most desired (i.e., cities), the space to properly house a store to sell these products is at an ultra-premium. Further, many of these clients are very busy and do not wish to travel long distances to find a store of appropriate size to view these things. For this reason, shopping for closets, and other home fixtures is often put aside and not addressed. As such, there is a need for a device that can show a potential customer a large variety of blinds, shades, closets, and other dome decor, that does not take up too much space, and can be brought to the customer's door, such as a mobile showroom. To date, no window accessory mobile retail space has been created until the present invention. Consumers traditionally purchases closest, window accessories and treatments directly in showrooms present at retail spaces. Often, this leads consumers to put these purchases aside. This invention solves this issue by bringing the showroom to the client's doorstep via a mobile showroom.

Review of related technology:

U.S. Pat. No. 9,135,649 discloses a mobile retail unit and associated network and method of use, where the mobile retail unit includes one or more of a customized-tint station and a climate-control system. The mobile retail unit also includes a computer-based system for storing inventory and order information, and which may include a network adapter configured to relay the inventory information and the order information over a wireless network between the computer-based system and a remote network center.

U.S. Pat. No. 8,864,207 discloses a mobile vending trailer. In at least one embodiment, a solar-powered mobile vending apparatus includes: a portable chassis; a housing; at least one vending machine configured to be stored and transported in the housing; a solar panel array configured to capture sunlight and convert the captured sunlight into electricity, thereby to provide solar power to the vending machine; a plurality of batteries configured for charge from the electricity generated from the solar panel array in order to provide power to the at least one vending machine; a controller configured to control the solar panel array and the plurality of batteries; and at least one lift configured to lower and raise the vending machine. The solar-powered mobile vending apparatus is adapted for use both off-grid and on-grid. In various embodiments, the apparatus also includes one or more of a wind turbine, generator, inverter, and combiner.

U.S. Pat. No. 6,969,102 teaches a mobile studio for designing and/or fabricating corrugated paperboard products includes a cutting table disposed in the enclosure for cutting and scoring sheets of corrugated paperboard. A computer is also disposed in the enclosure for designing the product and controlling the cutting table. The studio may be transported to a customer's location to design and fabricate a prototypical corrugated paperboard product (e.g. POP displays and packaging) on-site.

U.S. Pat. No. 8,955,897 teaches a mobile repair and response unit is a truck with an attached trailer that includes a plurality of uniquely defined compartments and areas that are each provided to accomplish a particular task. The attached trailer contains a cabin within which a customer may stay while the customer's vehicle is being repaired. The attached trailer includes a tire balancing station adjacent to a tire changing station. An opposing side of the attached trailer includes a plurality of pump stations that dispense different types of fuels or lubricating oils that are customarily used to operate different types of vehicles. An air station is included on the attached trailer in order to provide pressurized air for use with pneumatically operated tools or to inflate tires of the vehicle being repaired. The rear of the attached trailer includes a ramp that folds down to enable entrance into the attached trailer.

U.S. Pat. No. 8,485,285 teaches a vehicle for transporting or vending refrigerated product having a peripheral body extending vertically from the supporting surface, the peripheral body having a driver area, retail area, and cooling area, a bulk head for dividing the retail area from the cooling area, an auxiliary power system for powering at least one electrical component, having a battery bank and a charging mechanism, the charging mechanism having a vehicle charging system, shore power charging system, and solar array charging system, the charging mechanism imparting electrical charge to the battery bank, where the electrical component is a temperature control system for maintaining the temperature of the cooling area within a desired temperature range.

U.S. Pat. No. 6,585,305 teaches a mobile showroom for displaying merchandise such as furniture and clothing, is comprised of a drivable truck body that has a freight section converted to a merchandise showroom with see-through panels and, optionally, scrolling displays that can be used to showcase the merchandise or show different types of merchandise, or to provide transparent sections through which the merchandise itself may be viewed.

U.S. Pat. No. 8,636,208 teaches a mobile retail store structure transportable to a plurality of different locations includes a trailer construction configured both exteriorly and interiorly for housing a plurality of storage bins wherein products and/or parts can be stored. Each trailer is a self-sufficient module which includes doors at one end of the trailer unit for entry and exit thereto, portable stairs for providing access to the entry doors, opposed side doors and associated walkways for allowing coupling to additional similarly constructed trailers, extendable canopies for providing a secure passageway between the respective coupled trailers, and a generator/HVAC system for providing heating, cooling and electrical power to each trailer unit. In one embodiment, a terminal is provided to allow a user to either browse electronically various items for selection and/or sale, or access a self-service check-out station to complete a transaction. A plurality of terminals can be coupled to communicate with a master server terminal over a wired/wireless network.

United States Patent Application Publication No.: 2014/0152035 teaches an enclosure for a vehicle includes a wall that has an opening therein, a floor, and a lowered portion that is recessed into the floor in an area of the floor proximate the opening in the wall.

International Patent Application No.: WO 2014/063139 teaches a mobile retail unit and associated network and method of use, where the mobile retail unit includes one or more of a customized- tint station and a climate-control system. The mobile retail unit also includes a computer-based system for storing inventory and order information, and which may include a network adapter configured to relay the inventory information and the order information over a wireless network between the computer-based system and a remote network center.

Various devices are known in the art. However, their structure and means of operation are substantially different from the present invention. Such devices fail to provide a device that is capable of showing someone multiple iterations of custom closets and light fixtures within a close proximity to their home. In addition, the present invention's mobile retail vehicle improvement such as modularity and power efficiency are ones not currently found in the prior art. At least one embodiment of this invention is presented in the drawings below, and will be described in more detail herein.

### SUMMARY OF THE EMBODIMENTS

A mobile retail motorized vehicle, having a motorized vehicle comprising an exterior compartment mounted on a plurality of wheels; the exterior compartment adapted and configured to hold a power source separate from the motorized vehicle power source; an exterior perimeter defined by at least one transparent enclosure and at least one entryway; said at least one transparent enclosure defined by a second exterior perimeter. The mobile retail motorized vehicle also has an internal compartment; the internal compartment having a retail showroom; the retail showroom adapted and configured for displaying a plurality of merchandise items; and wherein the internal compartment further comprises a plurality of displays; and a solar powered lighting source; and an audio and speaker system.

The external compartment has at least one cut out. The plurality of merchandise items includes at least one of window treatments, window accessories and closets. The power source further comprises a generator. The plurality of displays includes at least one of the window treatments; window accessories and closets. The at least one cut out is adapted and configured to hold a heating or cooling unit. The internal compartment comprises at least one base board heating unit. The at least one base board heating unit is disposed at the base of the internal compartment. The at least one entryway further comprises arm rails. The arm rails are adapted and configured to be detachable. The audio and speaker system is adapted and configured on the exterior perimeter of the motorized vehicle. The mobile retail motorized vehicle also is Internet enabled and wireless fidelity system. The mobile retail motorized vehicle also has a point or sale system. The point of sale system is controlled by the wireless fidelity system and is internet enabled. The motorized vehicle has a floor comprised of at least one of metal, tile, carpet or linoleum. The internal compartment is comprised of a plurality of closets and a plurality of closet configurations.

The present invention meets and exceeds the following objectives:

It is an object of the present invention wherein the plurality of closet configurations comprise at least one of draws, vertical bars, cabinets and shelves.

It is an object of the present invention wherein the internal compartment further comprises a plurality of window accessory displays.

It is an object of the present invention wherein the plurality of window accessory displays includes at least one of blinds, shades and motorized blinds and shades.

It is an object of the present invention wherein the at least one entryway is adapted and configured with a retractable and foldable stair way.

It is an object of the present invention wherein the at least one entryway is comprised of at least one of a single sliding door, double siding door, single hinged door and a double hinged door.

It is an object of the present invention wherein a perimeter of light emitting diodes disposed around the internal compartment.

It is an object of the present invention wherein the solar powered light source is disposed on the top portion of the exterior perimeter.

It is an object of the present invention wherein the transparent enclosure is comprised of at least one of glass, fiberglass, and other composite translucent materials.

It is an object of the present invention wherein the second exterior perimeter may be adapted, configured or designed as a plurality of objects and sceneries.

It is an object of the present invention wherein the second exterior perimeter is adapted and configured to appear as a television monitor; and

The present invention also comprises a mobile retail apparatus, having an exterior compartment; said exterior compartment mounted on a plurality of wheels and adapted and configured to hold a power source; an exterior perimeter defined by at least one glass enclosure and at least one entryway; said at least one glass enclosure defined by a second exterior perimeter; an internal compartment; said internal compartment comprised of a retail showroom; said retail showroom adapted and configured for displaying a plurality of merchandise items; and wherein the internal compartment further comprises a plurality of displays; and a solar powered lighting source; and an audio and speaker system.

### BRIEF DESCRIPTION OF THE DRAWINGS

FIG. 1 shows an illustration of a front perspective view of side panel of the present invention.

FIG. 2 shows an illustration of a rear perspective view of side and rear panels of the present invention.

FIG. 3 shows an illustration of a side elevation view of side and rear panels of the present invention.

FIG. 4 shows an illustration of a rear elevation view of rear panel of the present invention.

FIG. 5 shows an illustration of a front perspective of side panel of an alternative embodiment of the present invention.

FIG. 6 shows an illustration of a rear perspective of side and rear panels of an alternative embodiment of the present invention.

FIG. 7 shows an illustration of a side elevation view of side and rear panels of an alternative embodiment of the present invention.

FIG. 8 shows an illustration of a rear perspective view of panels with stair feature of the present invention.

FIG. 9 shows an illustration of a side elevation of panels with stair feature of the present invention.

FIG. 10 shows an illustration of an enlarged sectioned view from rear of the present invention.

FIG. 11 shows an illustration of an enlarged rear facing interior view of the present invention.

FIG. 12 shows an illustration of an enlarged partial interior perspective of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As a threshold matter, it should be stated that while the mobile retail motorized vehicle of the present invention is described in relation to blinds, closets, and other home furnishings, it may be equipped or modified to be a mobile retail showroom for any appropriately-sized products.

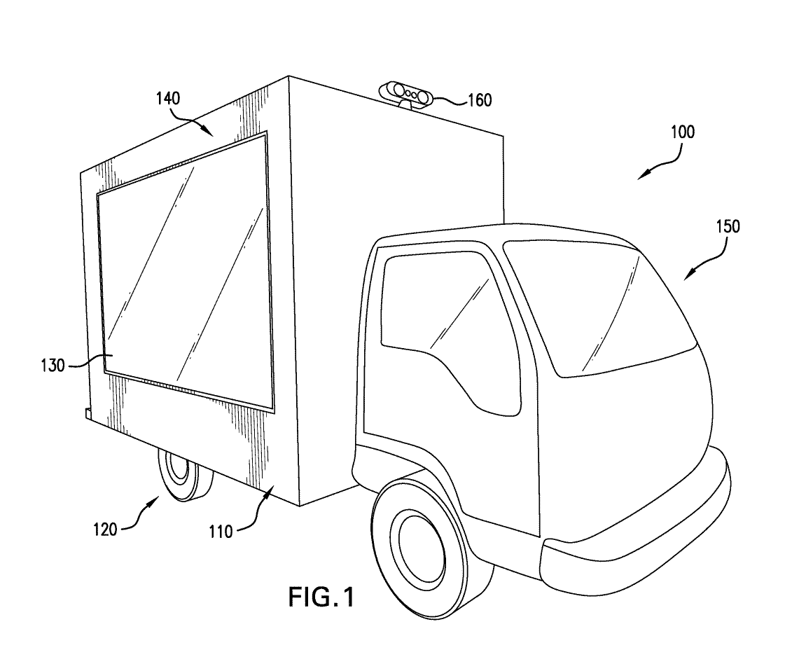

FIG. 1 shows a mobile retail motorized vehicle 100. The motorized vehicle may be any vehicle with any amount of wheels. The vehicle may be an automobile or car, motorcycle, tricycle, pickup truck, large truck such as an 18 wheeler or as pictured in the preferred embodiment, a motorized vehicle with a front cab 150. The front cab may be attached to an external compartment 110. The front cab may be where the driver sits. In another embodiment, the front cab 150 and the external compartment 110 which makes up the retail space may all be on component. In another embodiment, multiple external compartments can be connected by various means such as hook or cable system. In another embodiment, the front cab may be comprised of an area where the driver and additional passengers sit. In another embodiment, the front cab and the external compartment may be connected by another compartment where storage or additional individuals may travel. The external compartment may sit on a plurality of wheels 120 depending on the length of the external compartment 120 and the front cab 150.

The external compartment 110 is comprised of at least one transparent enclosure. The entire side of the external compartment may be made of glass or other such material. In another embodiment, only a portion of the sides of the external compartment may be made of glass so onlookers can see into the internal compartment. The transparent nature of each side of the external compartment may be due to glass, fiber glass or clear plastic. In another embodiment, only one side of the external compartment may be see through while the other sides are used for advertising the contents of the interior space or the business. Similarly the exterior of the external compartment may be comprised of additional advertising, such as electronic banners. The external compartment may also comprise an exterior perimeter around each glass enclosure that depicts a particular scene or object. For instance, in a preferred embodiment, the exterior perimeter 140 around the glass enclosure may appear to be a television monitor. The television monitor may be a sticker or decal or painted onto the external compartment. In another embodiment, the television monitor may be three dimensional so it appears as if the glass enclosure is actually the monitor of the television monitor outline. This allows for a person to feel as if they are in or on television from those passersby's looking in. In another embodiment, an internal projector located in the interior compartment may project various images and sceneries onto the glass enclosures. In such an embodiment, the glass enclosure may appear to be a bedroom, or a kitchen or a forest. In another embodiment, the projector may be on a timer and project images according to the time of day or according to the desire of the mobile retail truck owner. In another embodiment, the project image on the glass enclosure in conjunction may be interactive with the environment of those looking into the mobile retail truck. Also shown in FIG. 1 is a solar powered lighting source 160 which in a preferred embodiment is located on the top of the external compartment. In another embodiment, the solar powered lighting source may be disposed on any part of the external compartment 110. The solar powered light source is able to shine light onto the area in which the mobile retail unit sits.

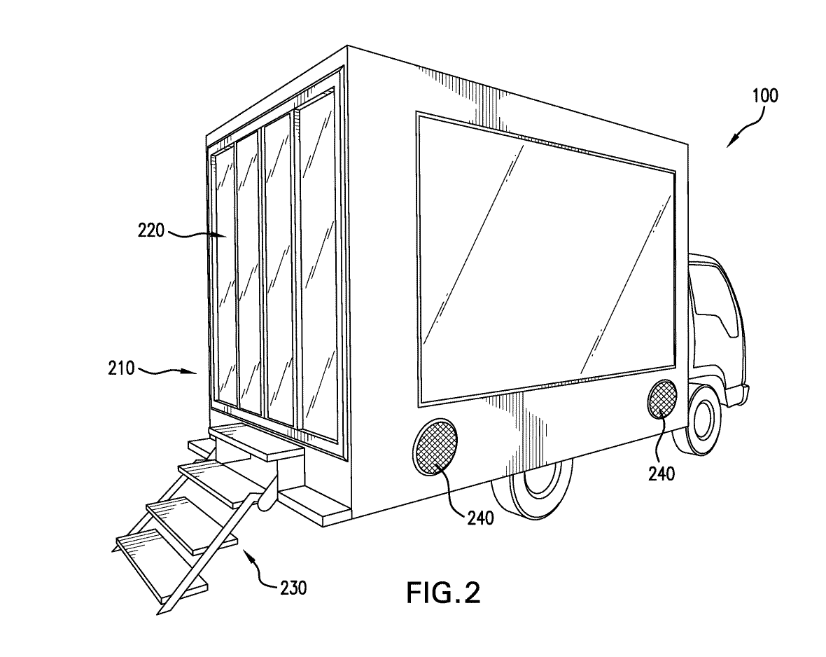

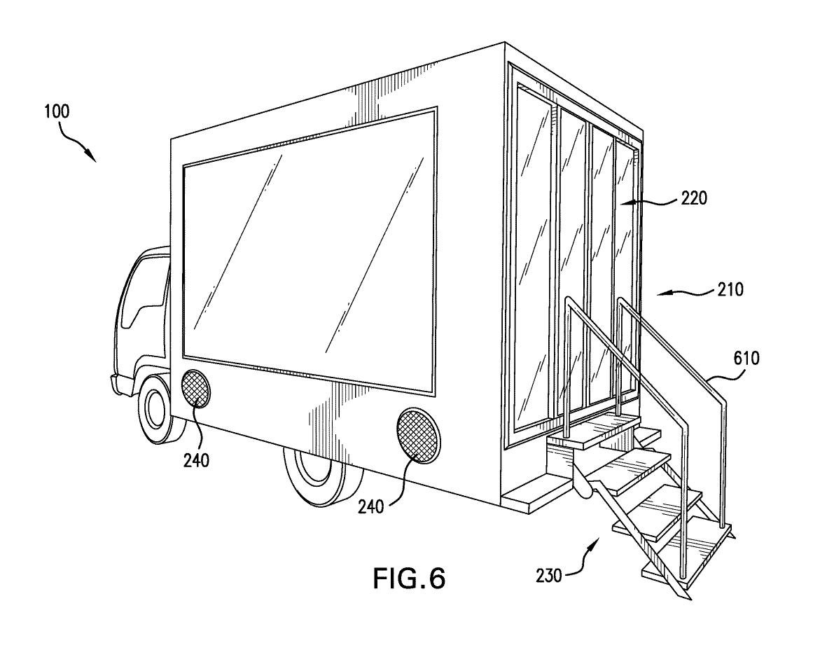

FIG. 2 shows the rear of the mobile retail vehicle 100. The rear of the truck is comprised of at least one entryway where consumers can enter the interior space. The entryway 210 may be accessible by a staircase 230 which is retractable and can be folded and pushed under the external compartment and out of view. When deployed, the staircase 230 allows entry into the entryway 210. In another embodiment of the invention, the entryway 210 may be located at any part of the external compartment 110. Similarly, the retractable and foldable stairs may be located in the same location of the entry way. The entryway 210 is comprised of a set of sliding doors which are locked. The sliding doors can be slid across their track thereby allowing full entry into the interior space. In another embodiment, the entry way may be enclosed by a one sliding door or a hinged door which can open into the interior compartment or can swing out. The hinged door may be located at either side and on any side of the exterior compartment 110. The external compartment 110 may also have at least one speaker 240 so that passersby's and potential customers can hear. As shown in FIG. 6, the staircase is comprised of detachable arm rails 610 which can easily be stored in the interior compartment when the mobile retail truck is mobile. When parked the arm rails offer support and security for those entering the internal compartment. In another embodiment, the stairs may be equipped with a ramp that can lay over the stairs to allow the physically disabled to enter the interior compartment.

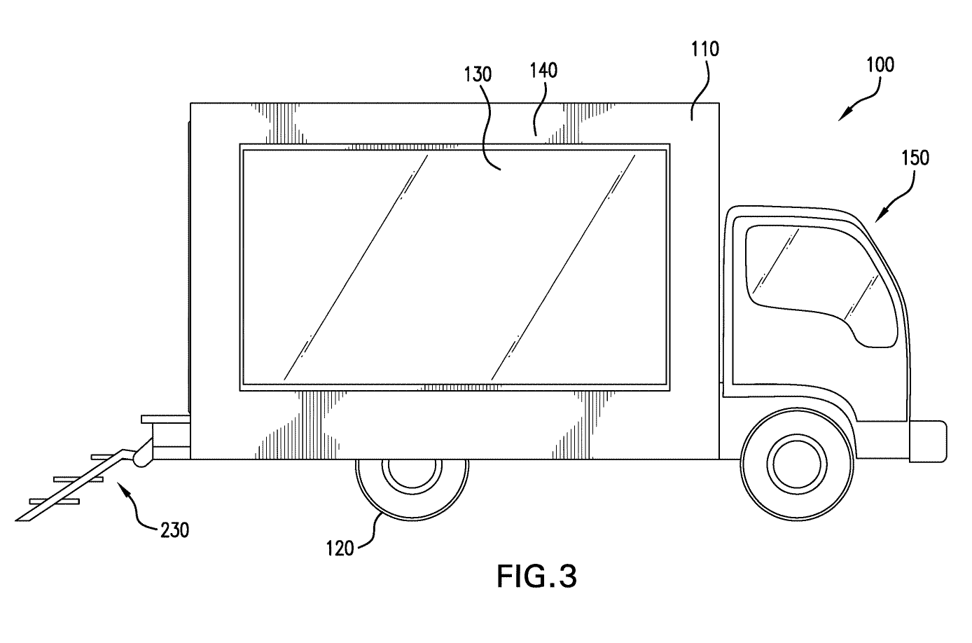

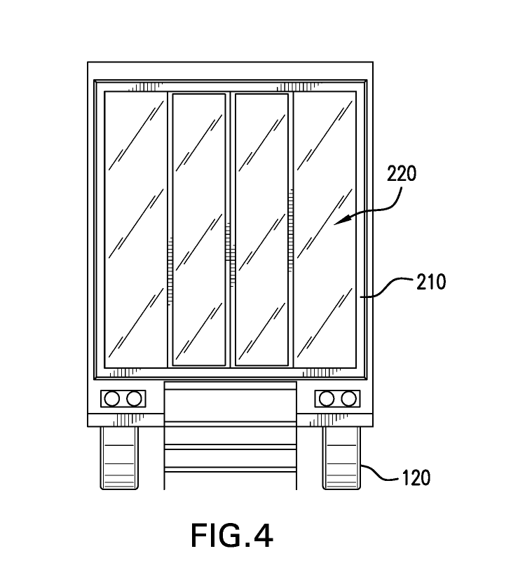

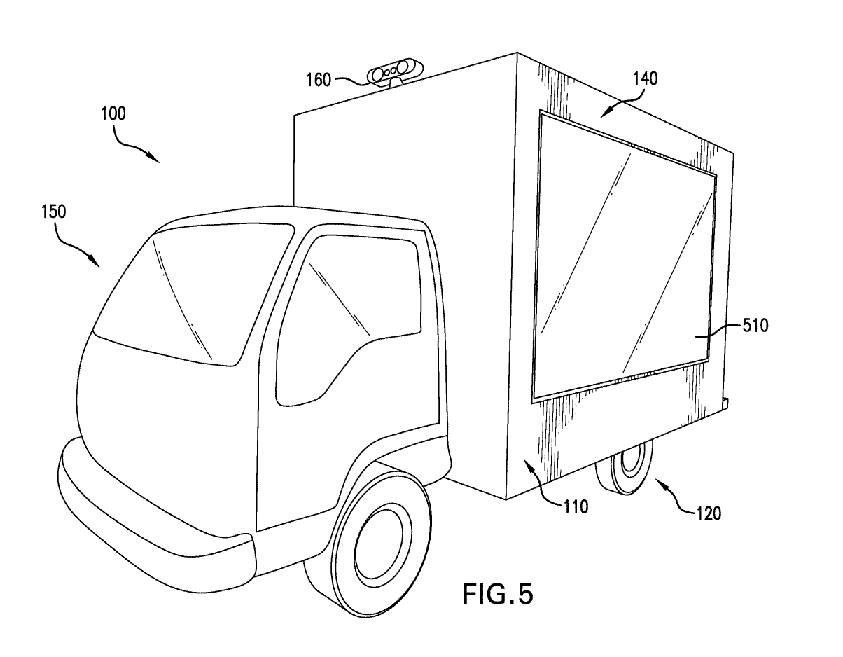

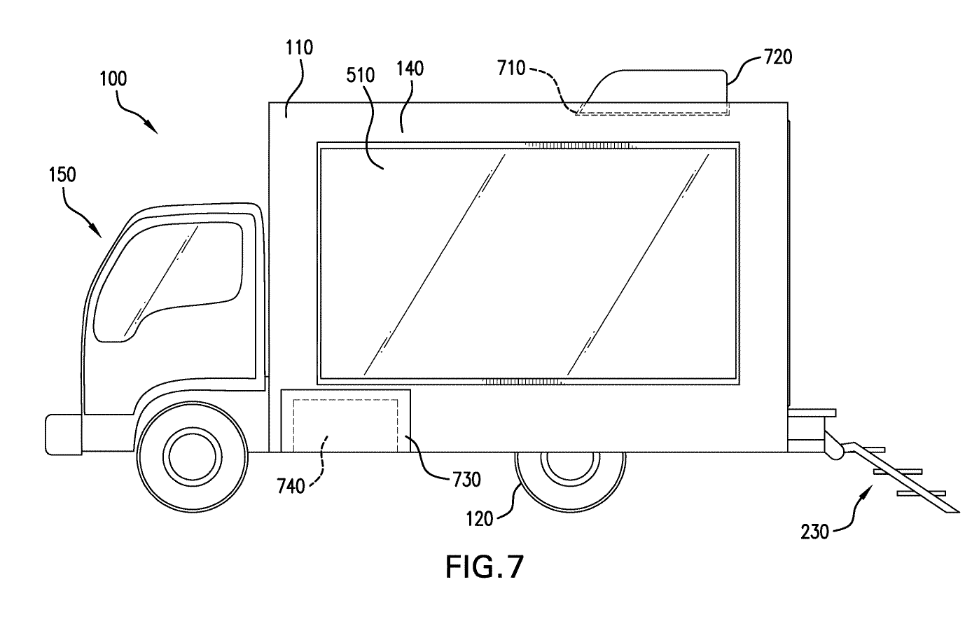

FIG. 3 is a side view of the mobile retail motorized vehicle 100. FIG. 4 is a rear view of the mobile retail motorized vehicle. FIG. 5 is a side view of the mobile retail motorized vehicle 100, specifically the opposite side glass enclosure 510 of the mobile retail vehicle. FIG. 7 shows a side view of the mobile retail motorized vehicle 100 and shows the cut out 710 that may be adapted and configured into the top of the exterior compartment. The cut out 710 may be equipped with a heating or cooling unit 720 that acts to warm or cool the interior compartment. The cut out 710 and the heating/cooling unit 720 may disposed on any side or surface of the exterior compartment. Also shown in FIG. 7 is a compartment adapted and configured into the exterior compartment. The compartment is able to house a generator 740. The compartment includes a door that may be locked to secure the generator inside. The compartment 730 may be disposed on any side of the external compartment. The generator is the main power source of all interior compartment systems. This allows for the mobile retail motorized vehicle to not only be efficient and green but also allows the motorized vehicle to run on power independent of the motorized vehicle. The motorized vehicle may be parked and its engine shut down and the generator may still power all the internal compartment systems. In a preferred embodiment the generator is gasoline powered, but in another embodiment, the generator is powered by renewable energy, such via solar panels or wind turbines. In another embodiment, any quiet and noise reducing device may work to power the interior components. In addition to creating a quiet retail experience, the motorized vehicle is not creating automobile emissions and thereby reduces its carbon footprint and acts to conserve overall energy. This ecofriendly, green and respect for the environment method of doing business is an added benefit to the present invention.

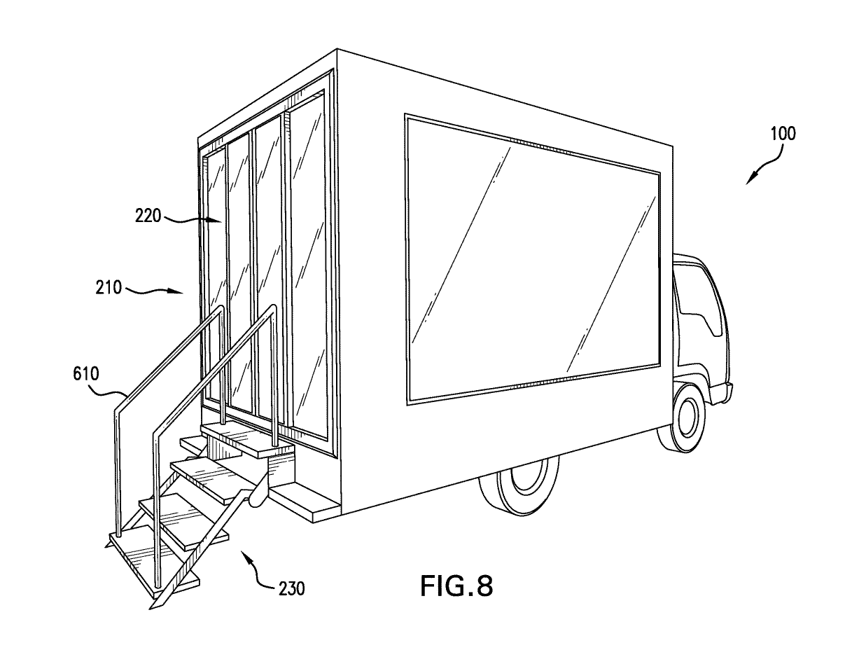

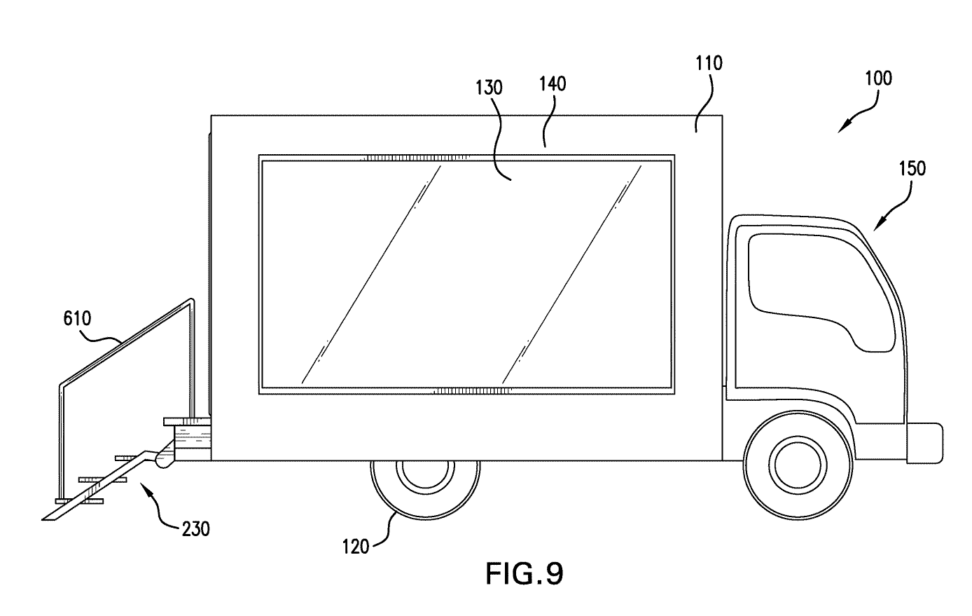

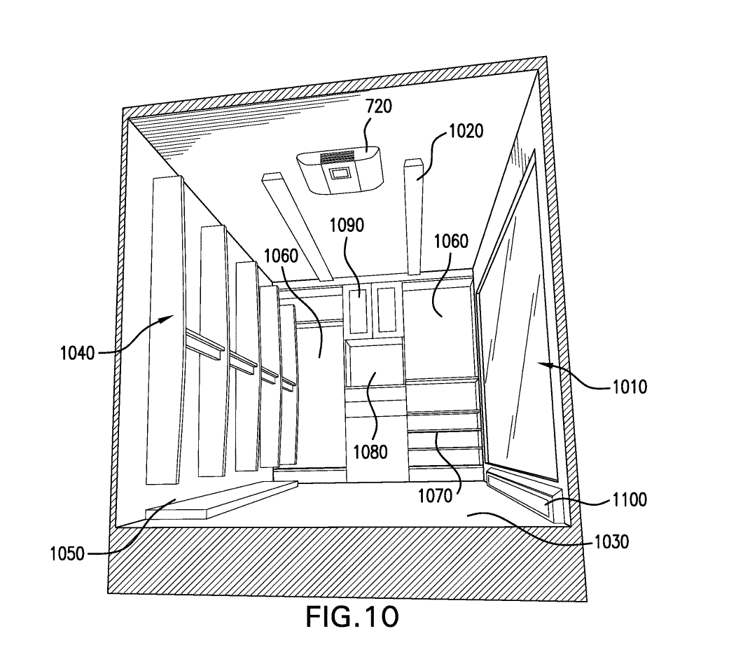

FIG. 8 shows an alternative rear view of the present invention. FIG. 9 shows an alternative side view of the present invention. FIG. 10 shows the preferred embodiment of the internal compartment of the present invention. The internal compartment 1010 is adapted and configured to sell a variety of products such as blinds, shades, window treatments, window accessories, closets, closet accessories and related items. As such its preferred and custom configuration is shown in FIG. 10. The internal compartment includes a floor 1030 which may be metal, carpet, tile, marble or other desired floor covering. The displays 1040 may be equipped with sample shades and blinds. The display base 1050 may be equipped to house and hold all sorts of styles of shades, blinds and window treatments. These window treatments may be electronic or motorized and thus the display base 1050 and plurality of displays 1040 may house electrical wires which can be controlled by a remote or by the generator. The internal compartment's temperature may be controlled by the heating or cooling unit 720 and additionally by base board heating 1100 which may be disposed at the bottom of the floor in any optimal location for providing the most efficient heat. The internal compartment may be lit up by overhead lighting 1020. Such interior lighting may be on tracks, florescent, or Light emitting diodes (LEDs). The interior lighting may be spot lights. The interior lighting may be disposed on any side or surface of the internal compartment. The internal compartment 1010 includes a representative closet 1060 with draws 1070 and multiple places to hang clothes, store shows, and store other household items. As the internal compartment is a retail space, there is a built in point of sale system which can be administered through a computer or television monitor which can be placed in to the open space 1080. The internal component is completely wireless and contains its own wireless fidelity (Wi-Fi) system, hot spot for Internet connection and internal audio and speaker system. All the closet components are movable and may slide in and out for multiple configurations. For example, in a preferred embodiment closet poles, racks, shoe racks and rods for hangers may be included. The internal compartment is completely modular so that the interior can be configured in multiple ways.

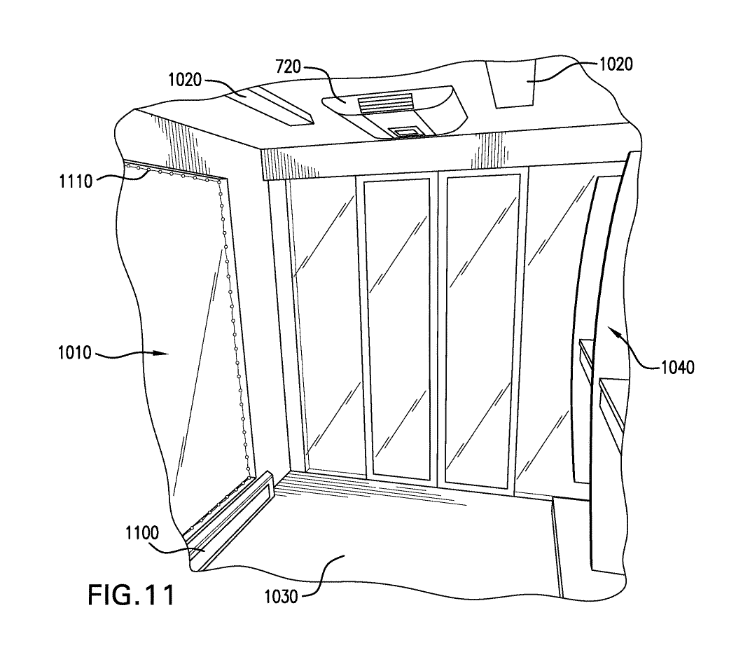

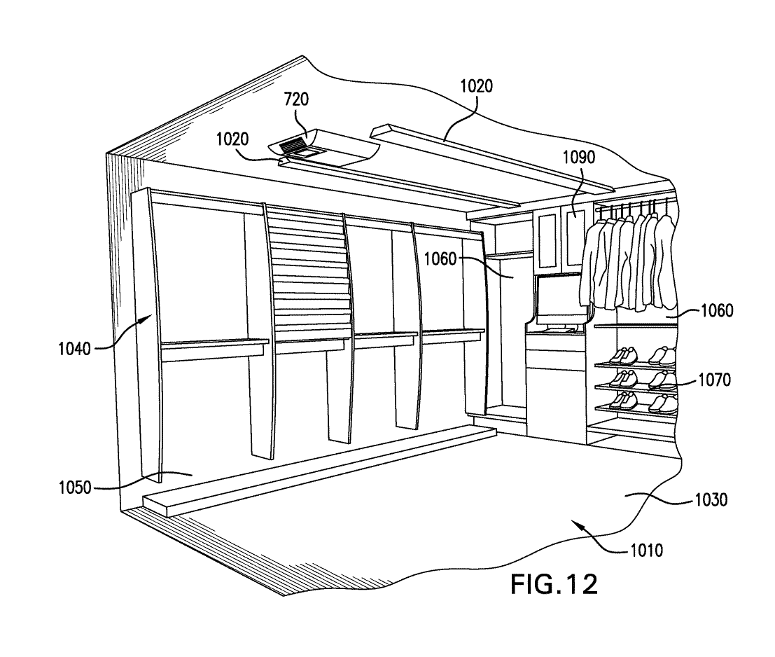

In another embodiment, the internal compartment may include a desk, walls or partitions that slide down from the ceiling of the internal compartment or that slide across from all to create privacy. The internal compartment may be used as a retail space, retail showroom, and repair shop, storage, sleeping quarter, design center or an office. The internal compartment may be equipped with fabric sample, draperies, fabric books, catalogues, removable and interchangeable fixtures and drapery and closet hardware. In another embodiment sample drapes, shades and blinds may be back lit or lit up by additional interior lighting. The shades may be roller shades or soft shades. In a preferred embodiment of the present invention, blinds, shades or drapes may be configured on each glass enclosure and/or may be of the type to black out incoming sunlight. In another embodiment a blind spinner may be attached to the floor of the internal compartment. A customer would be able to spin the blinds sample in a circle. In another embodiment, the floor of the interior compartment may be configured with tables. Such tables may be detachable and foldable. In another embodiment, the internal compartment may be equipped with a waiting area for retail clients to sit before entering into a conference area where consultations may occur. In another embodiment, the motorized vehicle may be equipped with multiple internal compartments for a variety of different functions. Each internal compartment may be connected from the inside. The internal systems of the internal compartment may be controlled by the generator or in another embodiment by the solar powered power source. The internal components and systems of the interior compartment may be controlled by a user's tablet or mobile computing device. As shown in FIG. 11 the interior perimeter corresponding to the transparent glass enclosure may be configured with LED's 1110. FIG. 12 shows a cut out view of the interior compartment of the present invention. The preferred embodiment comprises the following measurements: 12 feet in height from ground to top of truck, 5 feet from bottom of stairs to entryway; a 13 foot long exterior compartment; a 6 foot long cab with a 8 foot height; the width of the exterior compartment is 8 feet. The preferred embodiment measurements of the interior compartment are 12 feet in length, 7.5 feet in width, and 88.5 inches in height.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A mobile retail motorized vehicle, comprising:
a motorized vehicle comprising an exterior compartment mounted on a plurality of wheels;
said exterior compartment adapted and configured to hold a power source separate from a motorized vehicle power source;
an exterior perimeter defined by at least one transparent enclosure and at least one entryway;
said at least one transparent enclosure defined by a second exterior perimeter;
an internal compartment; said internal compartment comprised of a retail showroom; said retail showroom adapted and configured for displaying a plurality of merchandise items; and
wherein the internal compartment further comprises a plurality of displays; and
a solar powered lighting source; and
an audio and speaker system.

2. The motorized vehicle of claim 1, wherein the external compartment further comprises at least one cut out.

3. The motorized vehicle of claim 1, wherein the plurality of merchandise items includes at least one of window treatments, window accessories, and closets.

4. The motorized vehicle of claim 1, wherein the power source further comprises a generator.

5. The motorized vehicle of claim 1, wherein the plurality of displays includes at least one of the window treatments, window accessories, and closets.

6. The motorized vehicle of claim 1, wherein the at least one cut out is adapted and configured to hold a heating or cooling unit.

7. The motorized vehicle of claim 1, wherein the internal compartment comprises at least one base board heating unit.

8. The motorized vehicle of claim 1, wherein the at least one base board heating unit is disposed at the base of the internal compartment.

9. The motorized vehicle of claim 1, wherein said at least one entryway further comprises arm rails; said arm rails adapted and configured to be detachable.

10. The motorized vehicle of claim 1, wherein the audio and speaker system is adapted and configured on the exterior perimeter of the motorized vehicle.

11. The motorized vehicle of claim 1, further comprising an Internet enabled and wireless fidelity system.

12. The motorized vehicle of claim 1, further comprising a point or sale system.

13. The motorized vehicle of claim 1, wherein the point of sale system is controlled by the wireless fidelity system and is internet enabled.

14. The motorized vehicle of claim 1, further comprising a floor comprised of at least one of metal, tile, carpet or linoleum.

15. The motorized vehicle of claim 1, wherein the internal compartment is comprised of a plurality of closets and a plurality of closet configurations.

16. The motorized vehicle of claim 1, wherein the plurality of closet configurations comprise at least one of draws, vertical bars, cabinets and shelves.

17. The motorized vehicle of claim 1, wherein the internal compartment further comprises a plurality of window accessory displays.

18. The motorized vehicle of claim 17, wherein the plurality of window accessory displays includes at least one of blinds, shades and motorized blinds and shades.

19. The motorized vehicle of claim 1, wherein the at least one entryway is adapted and configured with a retractable and foldable stair way.

20. The motorized vehicle of claim 1, wherein the at least one entryway is comprised of at least one of a single sliding door, double siding door, single hinged door and a double hinged door.

21. The motorized vehicle of claim 1, further comprising a perimeter of light emitting diodes disposed around the internal compartment.

22. The motorized vehicle of claim 1 wherein the solar powered light source is disposed on the top portion of the exterior perimeter.

23. The motorized vehicle of claim 1, wherein the transparent enclosure is comprised of at least one of glass, fiberglass, and other composite translucent materials.

24. The motorized vehicle of claim 1, wherein the second exterior perimeter may be adapted, configured or designed as a plurality of objects and sceneries.

25. The motorized vehicle of claim 1, wherein the second exterior perimeter is adapted and configured to appear as a television monitor.

26. A mobile retail apparatus, comprising:
an exterior compartment; said exterior compartment mounted on a plurality of wheels and adapted and configured to hold a power source;
an exterior perimeter defined by at least one glass enclosure and at least one entryway;
said at least one glass enclosure defined by a second exterior perimeter; an internal compartment; said internal compartment comprised of a retail showroom;
said retail showroom adapted and configured for displaying a plurality of merchandise items;
wherein the internal compartment further comprises a plurality of displays; and
a solar powered lighting source; and
an audio and speaker system.
